(19) United States
(12) Patent Application Publication
(10) Pub. No.: US 2025/0312629 A1
(43) Pub. Date: Oct. 9, 2025

(54) METHOD AND APPARATUS FOR ANCHORING WITHIN A CHANNEL

(71) Applicant: Pure Safety Group, Inc., Pasadena, TX (US)

(72) Inventor: Judd J. Perner, Missouri City, TX (US)

(73) Assignee: Pure Safety Group, Inc., Pasadena, TX (US)

(21) Appl. No.: 19/091,340

(22) Filed: Mar. 26, 2025

Related U.S. Application Data
(60) Provisional application No. 63/573,672, filed on Apr. 3, 2024.

(51) Int. Cl. A62B 35/00

(52) U.S. Cl. CPC A62B 35/0081; A62B 35/0068

(57) ABSTRACT

An anchor for anchoring within a channel comprises a first anchor portion, a second anchor portion, and a connecting member interconnecting the first anchor portion and the second anchor portion. The first and second anchor portions are independently rotatable about and slidable along the connecting member between an anchor position and an installation position, the installation position having a narrower width than the anchor position relative to a longitudinal axis of the connecting member.

### CROSS-REFERENCE TO RELATED APPLICATIONS

This application claims the benefit of U.S. Provisional Patent Application Ser. No. 63/573,672, filed Apr. 3, 2024, which is incorporated herein by reference in its entirety.

### BACKGROUND

During construction or maintenance of a building, a worker performing tasks at a height or where there is a risk of falling connects fall protection equipment to a support structure to protect against a fall. Example fall protection equipment includes a safety harness donned by the worker and a lifeline interconnecting the safety harness and a support structure. An example of a support structure is a strut, which forms a channel, in an overhead structure. An anchor can be inserted within the channel to connect the lifeline to the strut, and the anchor can move within the channel so that the worker can move along the length of the strut. Anchors including separate components pose a risk of dropping component(s) and may require two-handed assembly and installation. In addition to being an inconvenience, dropped component(s) pose a risk of injury to any workers below.

For the reasons stated above and for other reasons stated below, which will become apparent to those skilled in the art upon reading and understanding the present specification, there is a need in the art for an improved method and apparatus for anchoring within a channel.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, an anchor for anchoring within a channel comprises a first anchor portion, a second anchor portion, and a connecting member interconnecting the first anchor portion and the second anchor portion. The first and second anchor portions are independently rotatable about and slidable along the connecting member between an anchor position and an installation position, the installation position having a narrower width than the anchor position relative to a longitudinal axis of the connecting member.

In one embodiment, an anchor for anchoring within a channel comprises a first anchor portion, a second anchor portion, a connecting member, and a securing member. The first anchor portion has a first base including a first aperture, and the second anchor portion has a second base including a second aperture. The connecting member interconnects the first anchor portion and the second anchor portion, and the first and second anchor portions are independently rotatable about and slidable along the connecting member between an anchor position and an installation position. The first aperture and the second aperture are aligned in the anchor position, and the installation position has a narrower width than the anchor position relative to a longitudinal axis of the connecting member. The securing member is configured and arranged to extend through the first aperture and the second aperture in the anchor position thereby securing the first and second anchor portions in the anchor position.

In one embodiment, a method of anchoring within a channel of a support structure comprises obtaining an anchor. The anchor includes a connecting member interconnecting a first anchor portion and a second anchor portion. The first and second anchor portions are independently rotatable about and slidable along the connecting member between an anchor position and an installation position. The installation position has a narrower width than the anchor position relative to a longitudinal axis of the connecting member. The anchor is positioned in the installation position, inserted into the channel of the support structure, and positioned in the anchor position.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a perspective view of an embodiment anchor to which a securing member is connected in an anchor position constructed in accordance with the principles of the present invention.

FIG. 2 is a perspective view of the anchor shown in FIG. 1 in the anchor position with the securing member removed.

FIG. 3 is a perspective view of the anchor shown in FIG. 2 in an intermediate position.

FIG. 4 is a perspective view of the anchor shown in FIG. 2 in an installation position.

FIG. 5 is an exploded perspective view of the anchor shown in FIG. 2.

FIG. 6 is an exploded side view of the anchor shown in FIG. 2.

FIG. 7 is an exploded top view of the anchor shown in FIG. 2.

FIG. 8 is a perspective view of the anchor and the securing member shown in FIG. 1 in the anchor position positioned within a channel of a support structure.

FIG. 9 is a perspective view of the anchor positioned within the channel of the support structure shown in FIG. 8 in the anchor position with the securing member removed.

FIG. 10 is a perspective view of the anchor positioned within the channel of the support structure shown in FIG. 9 in an intermediate position.

FIG. 11 is a perspective view of the anchor positioned within the channel of the support structure shown in FIG. 9 in another intermediate position.

FIG. 12 is a perspective view of the anchor positioned within the channel of the support structure shown in FIG. 9 in an installation (removal) position.

FIG. 13 is a perspective view of the anchor positioned within the channel of the support structure shown in FIG. 9 in an installation (removal) position.

FIG. 14 is a perspective view of the anchor removed from the channel of the support structure shown in FIG. 9 in an installation (removal) position.

FIG. 15 is a perspective view of the anchor positioned within the channel of the support structure shown in FIG. 9 in an installation (removal) position.

FIG. 16 is a perspective view of the anchor positioned within the channel of the support structure shown in FIG. 9 in an installation (removal) position.

FIG. 17 is a perspective view of the anchor positioned within the channel of the support structure shown in FIG. 9 in an installation (removal) position.

FIG. 18 is a perspective view of the anchor positioned within the channel of the support structure shown in FIG. 9 in an anchor position.

FIG. 19 is a side view of the anchor positioned within the channel of the support structure shown in FIG. 18 in an anchor position with a securing member connected to the anchor.

FIG. 20 is a perspective view of the anchor positioned within the channel of the support structure shown in FIG. 19 in an anchor position with a securing member connected to the anchor.

FIG. 21 is a front view of the anchor positioned within the channel of the support structure shown in FIG. 19 in an anchor position with a securing member connected to the anchor.

FIG. 22 is a side view of the anchor positioned within the channel of the support structure shown in FIG. 9 in the anchor position showing how the anchor engages the support structure in hidden lines.

FIG. 23 is a side view of the anchor positioned within the channel of the support structure shown in FIG. 9 in an intermediate position showing how the anchor engages the support structure in hidden lines.

FIG. 24 is an exploded perspective view of another embodiment anchor constructed in accordance with the principles of the present invention.

FIG. 25 shows various views of components of the anchor shown in FIG. 24.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide an anchor with interconnected components to facilitate easy installation within a channel of a support structure with a reduced risk of dropping the component(s). A first anchor portion is slidably operatively connected to a second anchor portion, such that one-handed operation during installation could even be performed. Once installed, the first and second anchor portions are secured in an anchor position with a securing member. The securing member not only prevents the first and second anchor portions from moving out of the anchor position but can provide a connection point for fall protection equipment.

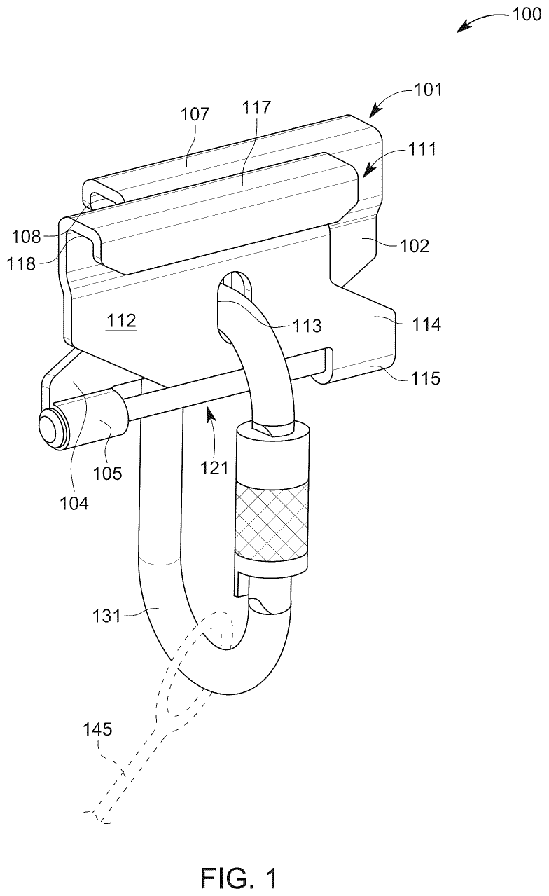

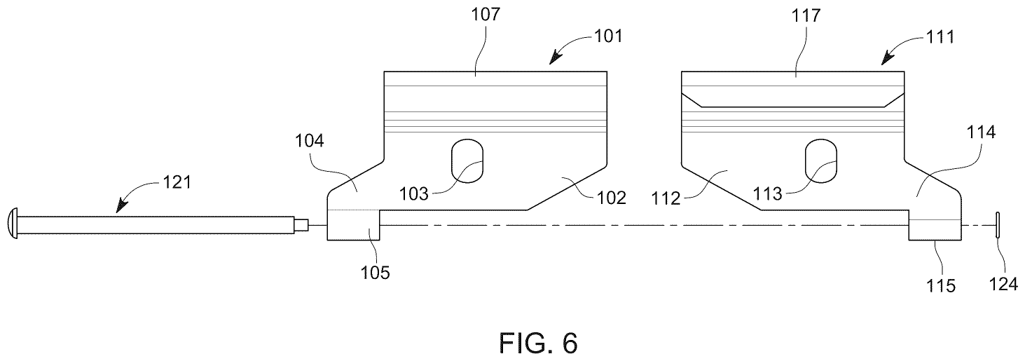

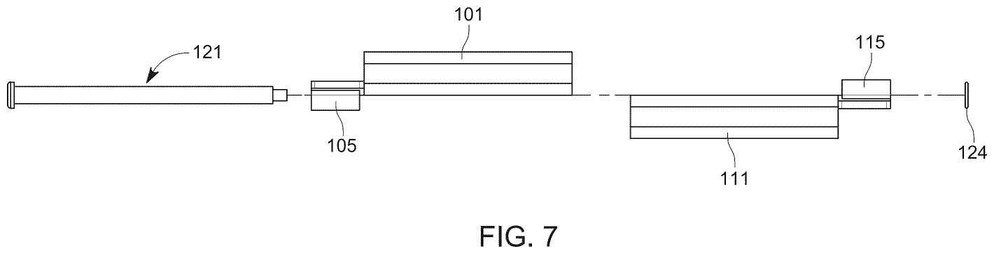

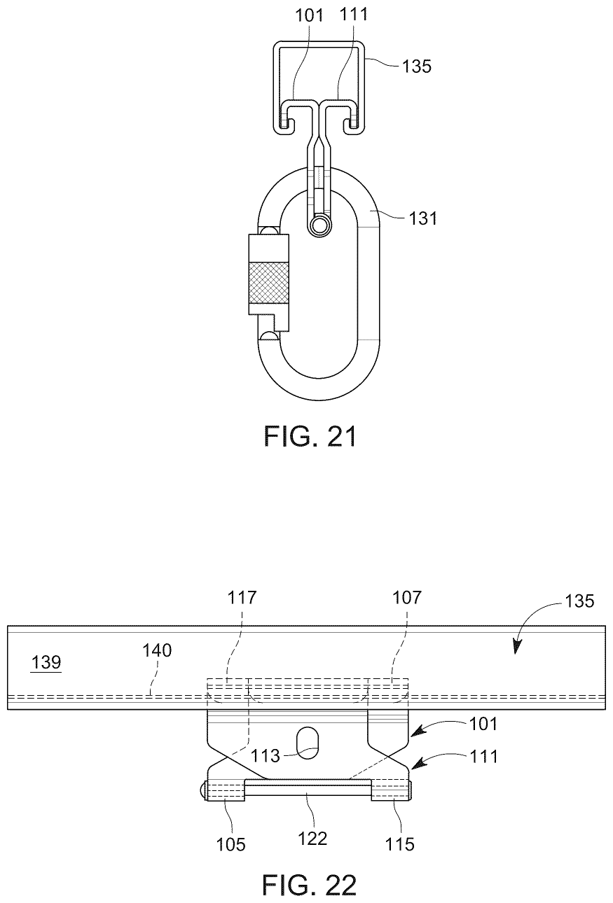

In one embodiment, illustrated in FIGS. 1-23, an anchor 100 includes a connecting member 121 slidably interconnecting a first anchor portion 101 and a second anchor portion 111. Preferably, for ease of manufacture, the first and second anchor portions 101 and 111 are identical, but it is recognized that they could have different configurations. A securing member 131 secures the first and second anchor portions 101 and 111 in an anchor position 152.

The first anchor portion 101 includes a base 102 through which an aperture 103 laterally extends proximate the middle. Preferably, the aperture 103 is a vertically oriented oval-shaped aperture configured and arranged to receive the securing member 131. The base 102 is generally rectangular with one bottom corner cut off and an extension 104 extending from the other bottom corner. The extension 104 includes a connecting portion 105, which is cylindrical and forms a longitudinal bore 106. An engaging portion 107 extends upward from the top of the base, in generally an inverted U-shape, and forms a channel 108. The connecting portion 105 extends inwardly and the engaging portion 107 extends outwardly relative to the base 102 when assembled.

Similarly, the second anchor portion 111 includes a base 112 through which an aperture 113 laterally extends proximate the middle. Preferably, the aperture 113 is a vertically oriented oval-shaped aperture configured and arranged to receive the securing member 131 and align with the aperture 103 in the anchor position 152. The base 112 is generally rectangular with one bottom corner cut off and an extension 114 extending from the other bottom corner. The extension 114 includes a connecting portion 115, which is cylindrical and forms a longitudinal bore 116. An engaging portion 117 extends upward from the top of the base, in generally an inverted U-shape, and forms a channel 118. The connecting portion 115 extends inwardly and the engaging portion 117 extends outwardly relative to the base 112 when assembled.

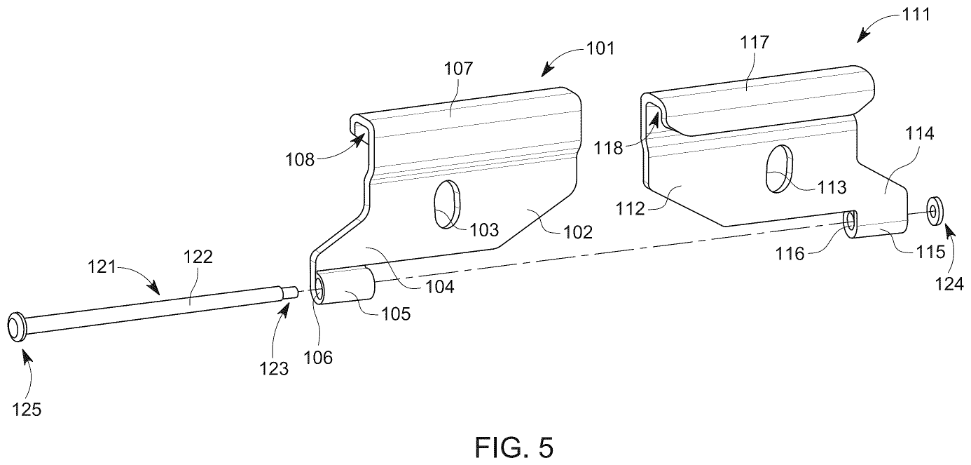

The first and second anchor portions 101 and 111 are positioned so that the connecting portions 105 and 115 extend inwardly, with the bores 106 and 116 aligning, and the engaging portions 107 and 117 extend outwardly, away from one another. The connecting member 121 extends through the bores 106 and 116, as shown in FIGS. 5-7, and the first and second anchor portions 101 and 111 can rotate and slide independently relative to the connecting member 121.

An example connecting member 121 includes a rod 122 with a first end 123 and a second end 125. The second end 125 can include a flange, which acts as a stop to prevent the first and second anchor portions 101 and 111 from sliding off the second end 125. A washer 124 can be positioned between the connecting portion and the first end 123. In one example, the washer 124 can rest on a shoulder on the rod 122 so that the rod 122 has a fixed length. When a rivet head is formed on the first end 123, the washer 124 is secured in place and the rivet head acts as a stop to prevent the first and second anchor portions 101 and 111, and the optional washer 124, from sliding off the first end 123.

Because the first and second anchor portions 101 and 111 can rotate and slide about the connecting member 121, they can be positioned along the connecting member 121 in various positions including an installation position 150, an anchor position 152, and intermediate positions 154. In the installation position 150, the engaging portions 107 and 117 are positioned generally in line (aligned) thereby narrowing the width of the anchor 100 relative to a longitudinal axis of the connecting member 121. In the anchor position 152, the engaging portions 107 and 117 are positioned generally parallel thereby widening the width of the anchor 100 relative to the longitudinal axis of the connecting member 121.

In the anchor position 152, the apertures 103 and 113 align and a securing member 131 such as a carabiner or other suitable fastener can be inserted through the apertures 103 and 113 to secure the first and second anchor portions 101 and 111 relative to one another. The anchor position 152 is shown best in FIGS. 1, 2, 8, 9, and 18. In this example, the cut off corners of the bases 102 and 112 provide clearance for the connecting portions 105 and 115. The securing member 131 can provide a connection point for a lifeline, a lanyard, or other suitable fall protection equipment, for example a lifeline 145 shown in dashed lines in FIG. 1.

With the securing member 131 removed, the first and second anchor portions 101 and 111 can independently rotate and slide relative to the connecting member 121. To position the anchor in the installation position 150, which is also the removal position, one of the anchor portions 101 or 111 is slid so that its connecting portion is proximate the other connecting portion, and the extensions 104 and 114 form notches so that the bases 102 and 112 can be rotated to generally align the engaging portions 107 and 117 thereby narrowing the width of the anchor 100. In the narrowed configuration, the anchor 100 is configured and arranged to be inserted into, or removed from, a channel of a support structure.

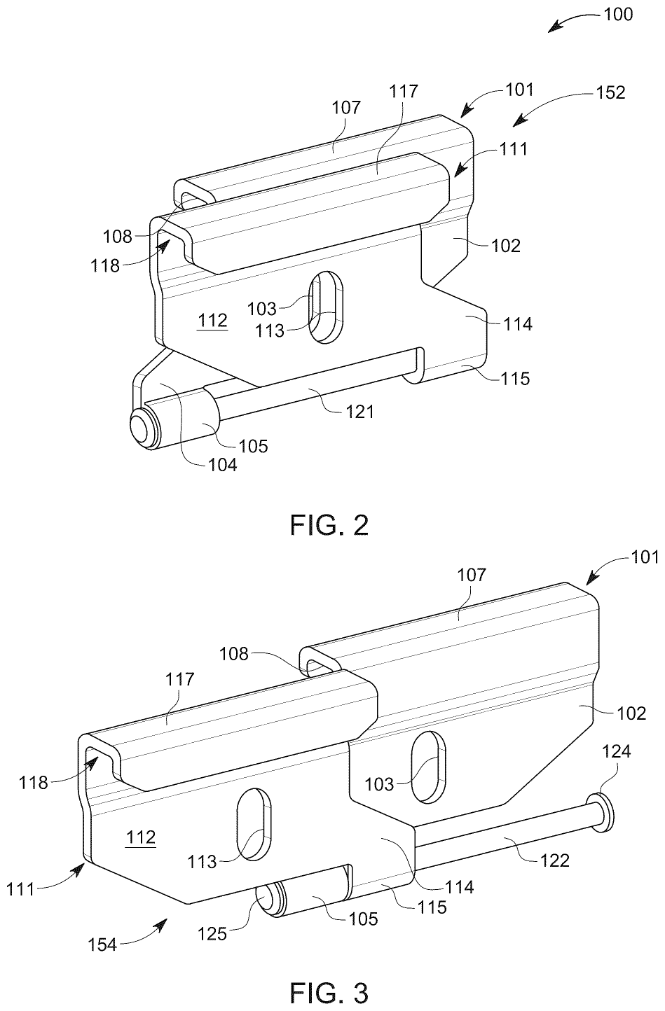

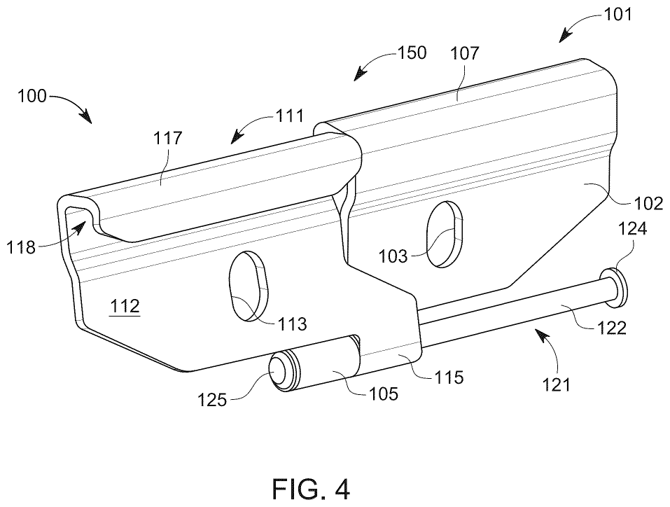

An example transition from the anchor position 152 to the installation position 150 is shown in FIGS. 1 to 4. In FIG. 1, the securing member 131 secures the first and second anchor portions 101 and 111 in the anchor position 152. In FIG. 2, the securing member 131 has been removed and the first and second anchor portions 101 and 111 are in the anchor position 152. In FIG. 3, the second anchor portion 111 is slid so that its connecting portion 115 is proximate the connecting portion 105, and the first and second anchor portions 101 and 111 are in an intermediate position 154. In FIG. 4, the second anchor portion 111 is rotated so that the engaging portions 107 and 117 generally align in the installation position 150.

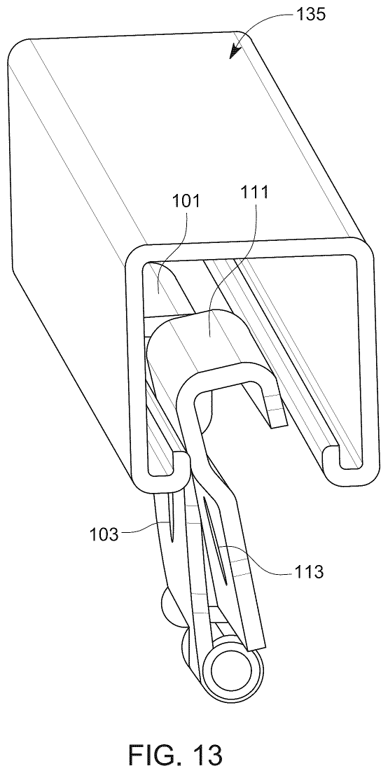

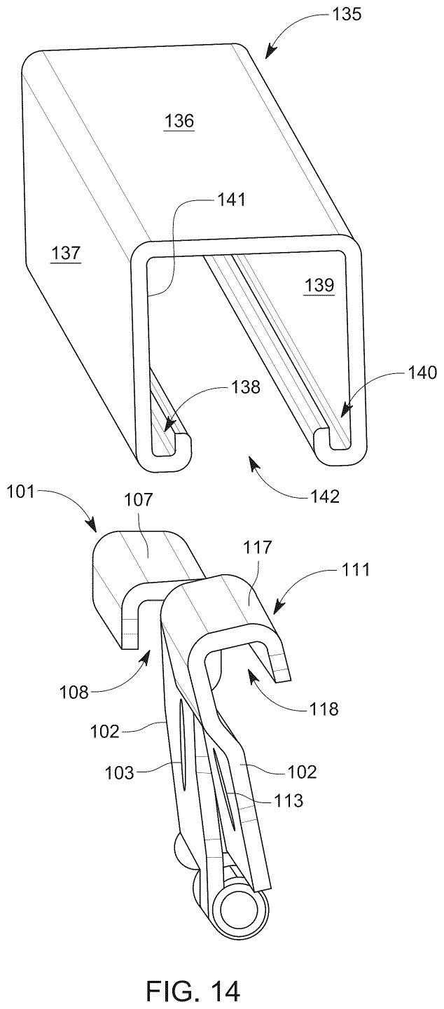

In the installation position 150, the anchor 100 can be installed to anchor within a channel of a support structure and be removed from the support structure. An example support structure, best shown in FIG. 14, is a strut 135, which includes a top 136 having opposing sides from which a first side 137 and a second side 139 extend to form an opening 142 into a cavity 141. The first side 137 forms a first channel 138, and the second side 139 forms a second channel 140. In this example, the first and second channels 138 and 140 support the engaging portions 107 and 117.

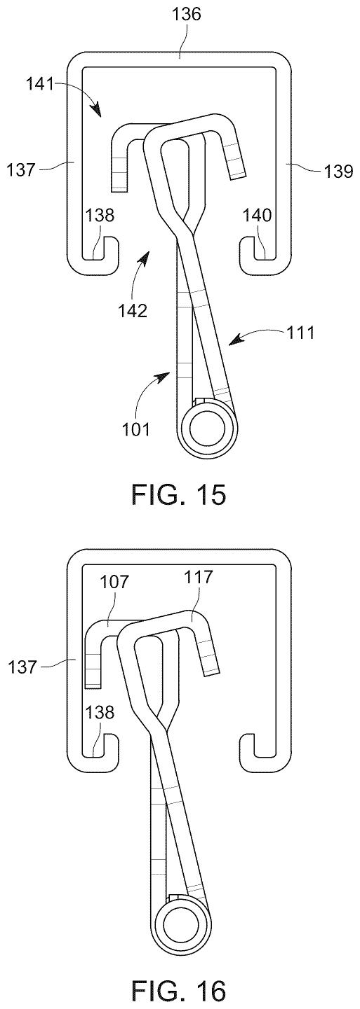

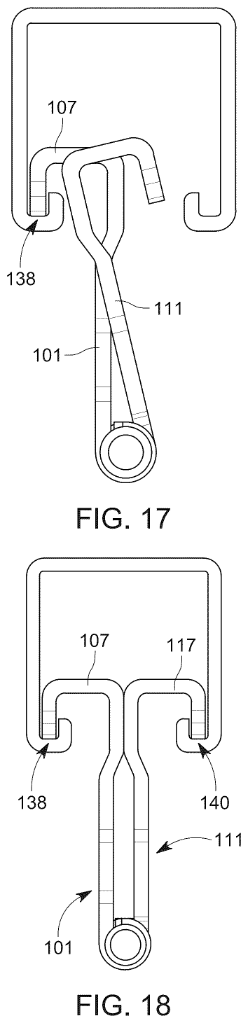

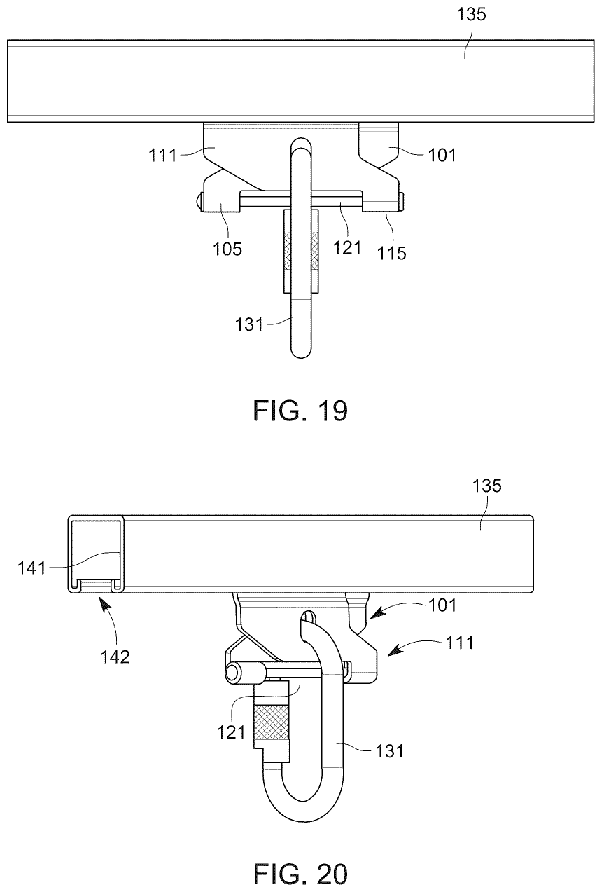

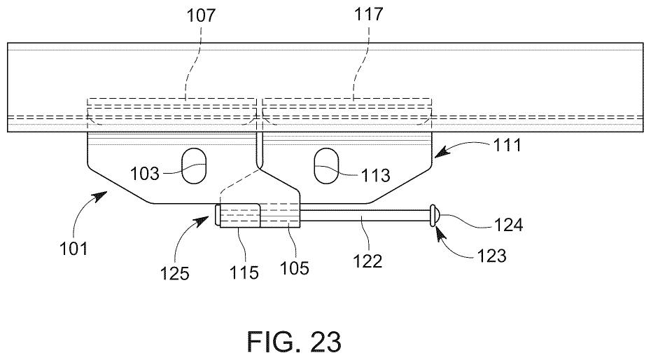

FIGS. 15-23 illustrate an example of how the anchor 100 can be installed to anchor within the channel. The anchor 100 is positioned in the installation position 150 so that the engaging portions 107 and 117 generally align. In this narrowed width configuration, the engaging portions 107 and 117 are inserted through the opening 142 and into the cavity 141 (FIG. 15). Then one of the engaging portions, engaging portion 107 in this example, is positioned within the first channel 138 (FIGS. 16-17). The base 111 is then rotated, slid along the connecting member 121, and positioned so that the engaging portion 117 is positioned within the second channel 140 (FIG. 18). Once the apertures 103 and 113 align, the securing member 131 can be inserted therethrough (FIGS. 19-21). FIGS. 22 and 23 illustrate, from opposing sides of the strut 135, how the engaging portions engage the first and second channels in hidden lines.

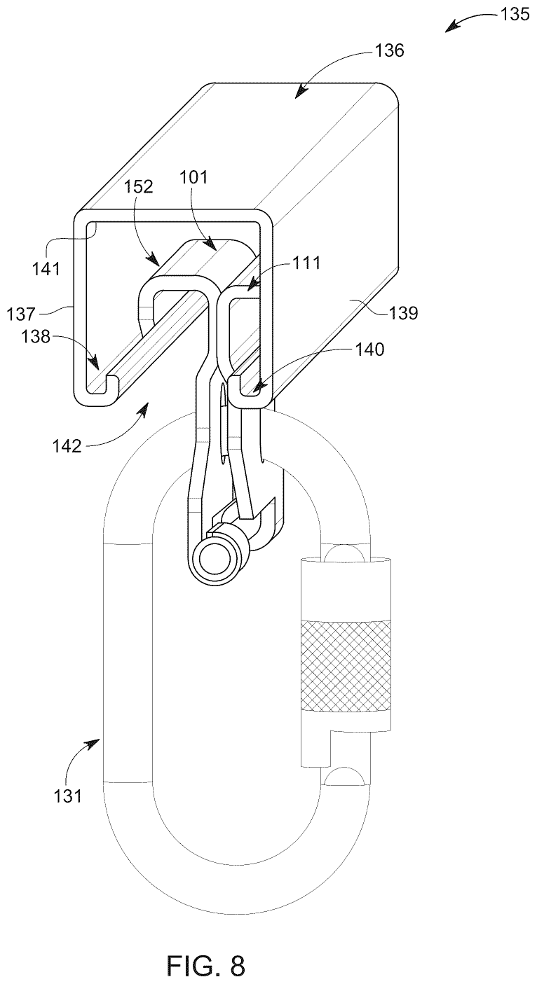

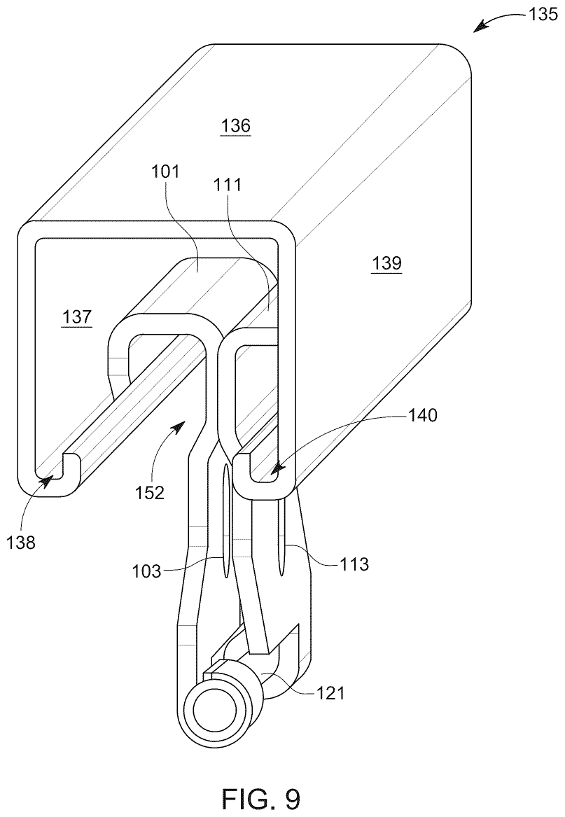

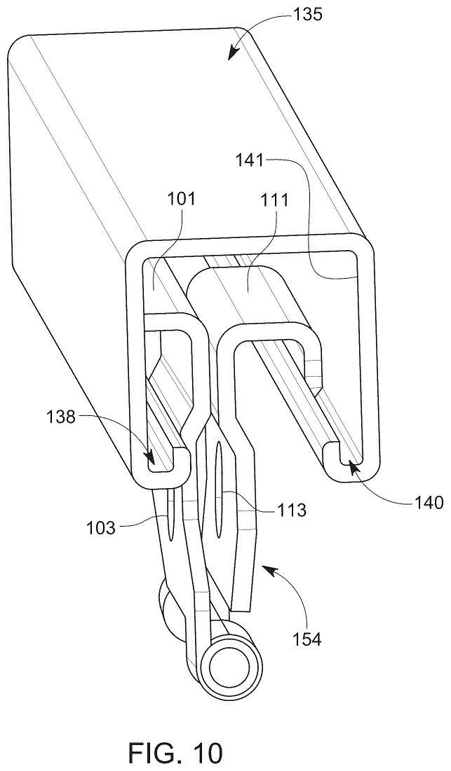

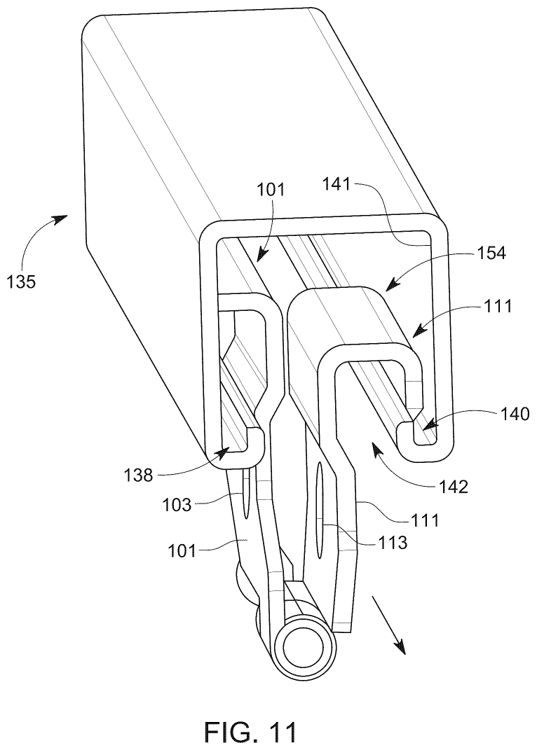

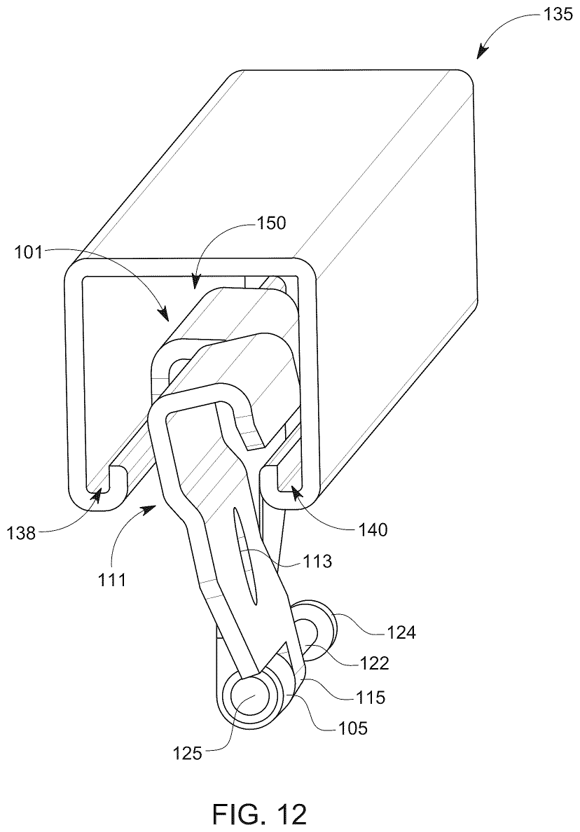

An example of how the anchor 100 can be removed from the support structure is shown in FIGS. 8-14. Removal can be similar to reversing the steps of installation. The anchor 100 is in the anchor position 152 in FIGS. 8 and 9, intermediate positions 154 in FIGS. 10 and 11, and the installation position 150 in FIGS. 12-14.

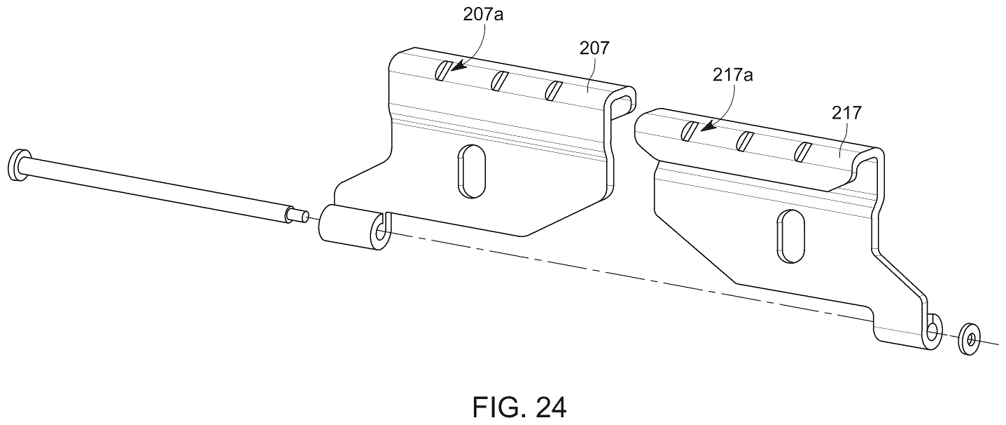

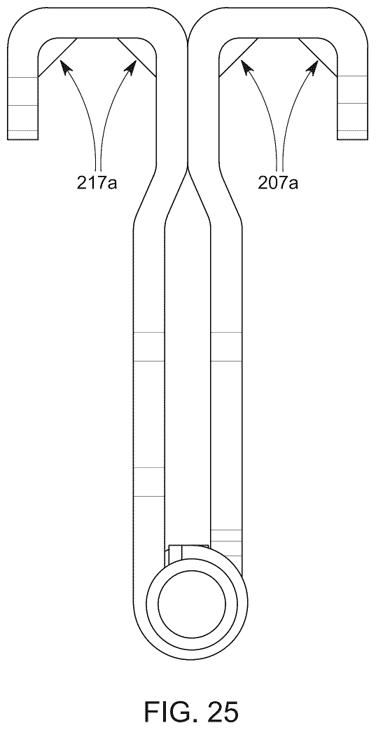

In another embodiment, illustrated in FIGS. 24-25, an anchor 200 includes similar components as anchor 100 and, therefore, only the significant differences will be described. Optional gussets 207a and 217a provide structure to strengthen the engaging portions 107 and 117 to prevent any deformation should a force (e.g., a force from a fall) be exerted on the anchor 200.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An anchor for anchoring within a channel, comprising:
a first anchor portion;
a second anchor portion; and
a connecting member interconnecting the first anchor portion and the second anchor portion, the first and second anchor portions being independently rotatable about and slidable along the connecting member between an anchor position and an installation position, the installation position having a narrower width than the anchor position relative to a longitudinal axis of the connecting member.

2. The anchor of claim 1, wherein the first anchor portion has a first base including a first aperture and the second anchor portion has a second base including a second aperture, the first and second apertures being aligned in the anchor position.

3. The anchor of claim 2, further comprising a securing member configured and arranged to extend through the first and second apertures in the anchor position thereby securing the first and second anchor portions in the anchor position.

4. The anchor of claim 1, wherein the first anchor portion includes a first connecting portion extending inwardly and a first engaging portion extending outwardly, and the second anchor portion includes a second connecting portion extending inwardly and a second engaging portion extending outwardly, the connecting member extending through the first and second connecting portions.

5. The anchor of claim 1, wherein the connecting member has a first end and a second end, the first connecting portion being positioned proximate the first end and the second connecting portion being positioned proximate the second end in the anchor position, and the first and second connecting portions being positioned proximate one another in the installation position.

6. The anchor of claim 1, wherein the connecting member is a rod.

7. The anchor of claim 1, wherein the first and second anchor portions are identical.

8. The anchor of claim 1, wherein each of the engaging portions includes at least one gusset.

9. An anchor for anchoring within a channel, comprising:
a first anchor portion having a first base including a first aperture;
a second anchor portion having a second base including a second aperture;
a connecting member interconnecting the first anchor portion and the second anchor portion, the first and second anchor portions being independently rotatable about and slidable along the connecting member between an anchor position and an installation position, the first aperture and the second aperture being aligned in the anchor position, the installation position having a narrower width than the anchor position relative to a longitudinal axis of the connecting member; and
a securing member configured and arranged to extend through the first aperture and the second aperture in the anchor position thereby securing the first and second anchor portions in the anchor position.

10. The anchor of claim 9, wherein the first anchor portion includes a first connecting portion extending inwardly and a first engaging portion extending outwardly, and the second anchor portion includes a second connecting portion extending inwardly and a second engaging portion extending outwardly, the connecting member extending through the first and second connecting portions.

11. The anchor of claim 9, wherein the connecting member has a first end and a second end, the first connecting portion being positioned proximate the first end and the second connecting portion being positioned proximate the second end in the anchor position, and the first and second connecting portions being positioned proximate one another in the installation position.

12. The anchor of claim 9, wherein the connecting member is a rod.

13. The anchor of claim 9, wherein the first and second anchor portions are identical.

14. The anchor of claim 9, wherein each of the engaging portions includes at least one gusset.

15. A method of anchoring within a channel of a support structure, comprising:
obtaining an anchor including a connecting member interconnecting a first anchor portion and a second anchor portion, the first and second anchor portions being independently rotatable about and slidable along the connecting member between an anchor position and an installation position, the installation position having a narrower width than the anchor position relative to a longitudinal axis of the connecting member;
positioning the anchor in the installation position;
inserting the anchor into the channel of the support structure; and
positioning the anchor in the anchor position.

16. The method of claim 15, wherein the first and second anchor portions include first and second apertures configured and arranged to align in the anchor position, further comprising inserting a securing member through the first and second apertures in the anchor position.

17. The method of claim 16, further comprising connecting a lifeline to the securing member.

18. The method of claim 16, wherein the anchor is slidable within the channel in the anchor position.
